(19) United States
(12) Patent Application Publication
(10) Pub. No.: US 2007/0123315 A1
(43) Pub. Date: May 31, 2007

(54) Method and system for charging a mobile phone with conventional DC batteries

(76) Inventor: Willie J. Williams JR., Frisco, TX (US)

Correspondence Address: MICHAEL L. DIAZ, P.C., 555 REPUBLIC DRIVE, SUITE 200, PIANO, TX, 75074, US

(21) Appl. No.: 11/287,915

(22) Filed: Nov. 28, 2005

(51) Int. Cl. H04B 1/38

(52) U.S. Cl. 455/573

(57) ABSTRACT

The present invention is an apparatus providing electrical power from conventional DC batteries to a mobile phone. The apparatus includes a main body having at least one battery receptacle. The receptacle includes a positive terminal and an oppositely mounted negative terminal. The spacing between the terminals is at a distance to accommodate a specific conventional battery, such as AA's, C's, or D's. Conventional batteries are inserted within the receptacles. The apparatus converts the power output from the conventional batteries into an acceptable voltage for use by the mobile phone. A power cable is then connected between the apparatus and a power port on the mobile phone, thereby providing electrical power to the mobile phone.

### FIELD OF THE INVENTION

This invention relates to portable power supplies. Specifically, the present invention relates to a system and method for charging a mobile phone with conventional DC batteries.

### DESCRIPTION OF THE RELATED ART

Mobile phones are a convenient way for people to communicate with others. The mobile phone allows anyone to travel away from their homes or offices while still maintaining contact with others. Mobile phones have essentially changed the face of the way people communicate today. However, although mobile phones are convenient and extremely portable, one of the primary concerns of a mobile phone user is the power supply. Because of the extremely small size of the mobile phone, the mobile phone battery provides power for a very limited time duration. Thus, most people have to frequently charge their mobile phones to ensure that their phones have an adequate charge. To charge a mobile phone, typically a mobile phone user must attach an AC adapter to the mobile phone and plug it into an AC plug outlet. The phone is then allowed to charge. This method of charging the phone is adequate, but there are some disadvantages.

Recently, there have been natural disasters which have resulted in extended periods of power outages. With these power outages, people quickly lost the use of their phones because of a lack of AC electrical power. Obviously, the use of a mobile phone during a natural disaster is important and oftentimes a life-saving tool. A system and method is needed which enable a mobile phone user to charge their mobile phone without the need of AC power.

It would be advantageous to have an apparatus which enables a mobile phone to be powered or charged by conventional DC batteries. It is an object of the present invention to provide such an apparatus.

### SUMMARY OF THE INVENTION

In one aspect, the present invention is a battery power unit for powering a mobile phone. The power unit includes a main body having at least one receptacle for housing a conventional battery. The receptacle has a positive terminal and a negative terminal. The electrical output from the conventional battery is converted to an acceptable voltage level appropriate for the mobile phone. A power cable is connected to the main body and attached to a power port of the mobile phone. At least one battery is positioned within the receptacle with the positive end of the battery aligned with the positive terminal and the negative end of the battery is aligned with the negative terminal. The power cable provides the power from the battery to the mobile phone.

In another aspect, the present invention is a method of powering a mobile phone. The method begins by inserting at least one conventional battery into a battery power unit. The electrical power from the conventional battery is then converted to an appropriate voltage for use by the mobile phone. A cable is attached from the battery power unit to the mobile phone. The mobile phone is then powered by the conventional battery.

In still another aspect, the present invention is a system of powering a mobile phone. The system includes a main body having at least one receptacle for housing a conventional battery. The receptacle has a positive terminal and a negative terminal. The electrical output from the conventional battery is converted to an acceptable level appropriate for the mobile phone. A power cable is connected to the main body. The power cable includes a phone adapter plug which is sized and shaped to fit within a power port of the mobile phone. At least one battery is inserted within the receptacle, with the positive end of the battery aligned with the positive terminal and the negative end of the battery is aligned with the negative terminal. The plug adapter is inserted into the power port of the mobile phone and the power unit provides power to the mobile phone.

### BRIEF DESCRIPTION OF THE DRAWINGS

FIG. 1 (prior art) is a front view of a conventional mobile phone;

FIG. 2 is a front view of a DC battery power unit in the preferred embodiment of the present invention;

FIG. 3 is a front view of the DC battery power unit of FIG. 2 having conventional batteries positioned within the receptacles and the power cord being attached to the power port of the mobile phone in the preferred embodiment of the present invention;

FIG. 4 is a front perspective view of a battery power unit having an optional AC adapter cable and AC plug in an alternate embodiment of the present invention.

### DESCRIPTION OF THE INVENTION

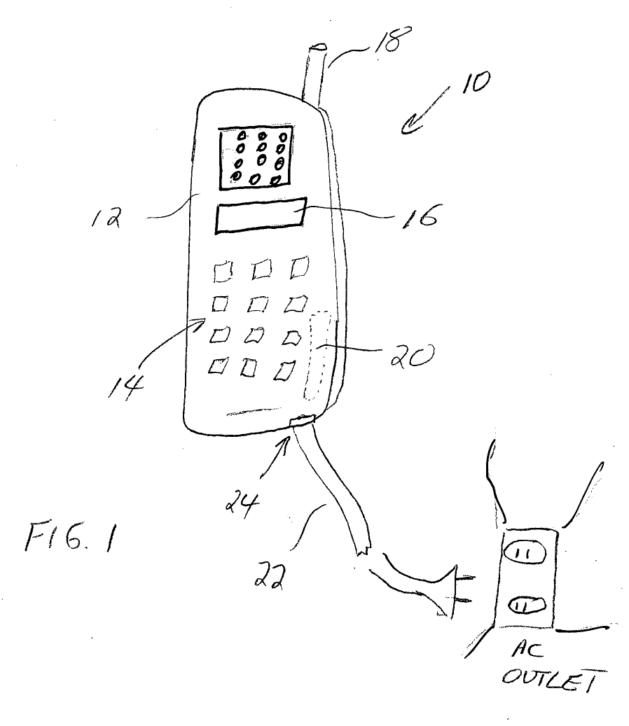

An apparatus for charging and powering a mobile phone with conventional DC batteries is disclosed. FIG. 1 is a front perspective view of a conventional mobile phone 10. The mobile phone 10 typically includes a headset 12 having a numeric keypad 14, a display screen 16, an antenna 18, and an internally mounted mobile phone battery 20. The internally mounted battery is typically a lithium ion battery which is usually specific for one particular model of a mobile phone. Thus, interchanging batteries is not possible. To charge the mobile phone battery 20, an AC adapter cable 22 is attached to a power port 24. The AC adapter cable 22 is then plugged into an AC electrical outlet. As discussed above, the user suffers from a great disadvantage if AC electrical power is not available, such as during a power outage or when an AC electrical outlet is not available (e.g., camping).

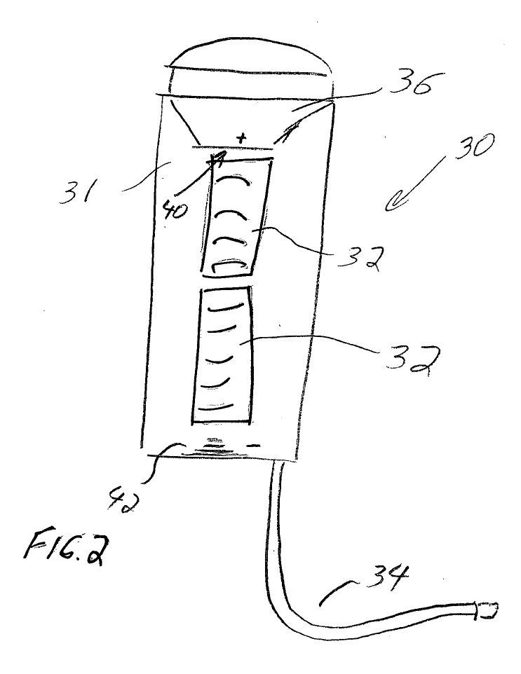

FIG. 2 is a front view of a DC battery power unit 30 in the preferred embodiment of the present invention. The battery power unit 30 includes a main body 31 having at least one and preferably several battery receptacles 32 for receiving one or more conventional batteries (e.g., AA's, C's, D's, etc.). The battery power unit may include a converter 36 for converting the voltage of the DC batteries into the voltage normally used by the mobile phone battery 20. The battery power unit also includes a power cord 34 having a plug sized and shaped to fit within the power port 24 of the mobile phone 10.

Each battery receptacle includes a positive terminal 40 and a negative terminal 42 located on an opposite end. The positive terminal and negative terminal are spaced an appropriate distance apart from each other to allow a conventional disposal/rechargeable battery to fit within the receptacle (not shown in FIG. 2). In the preferred embodiment of the present invention, the battery power unit includes a plurality of battery receptacles sized to accommodate different sizes of batteries (e.g., AA's, C's, D's, etc.).

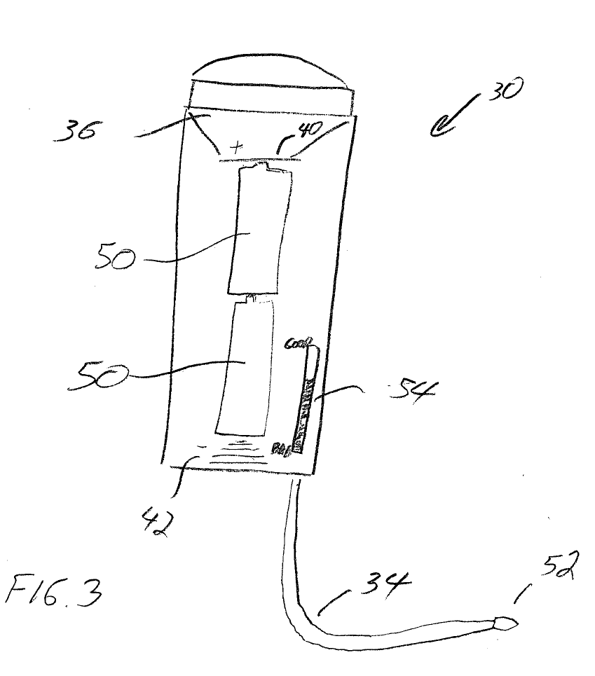

FIG. 3 is a front view of the DC battery power unit 30 of FIG. 2 having conventional batteries 50 positioned within the receptacles 32 and the power cord 34 being attached to the power port 24 of the mobile phone 10 in the preferred embodiment of the present invention. With the conventional batteries 50 installed within the receptacles 32, an adapter plug 52 at the end of power cord may be inserted into the power port 24 of the mobile phone. The converter 36 may be utilized to change, step up or down the voltage of the conventional batteries 50 to feed the appropriate electrical power to the mobile phone 10. As depicted in FIG. 3, the batteries are arranged in a tandem configuration with one battery's positive side touching the positive terminal of the power unit. A second battery's positive end touches the adjacent first battery's negative end. In addition, the second battery's negative end touches the negative terminal of the power unit. This in series arrangement may be utilized. In an alternate embodiment of the present invention, each battery touches one positive terminal and one negative terminal of the power unit. An optional indicator display 54 may be provided to indicate the battery strength of the conventional batteries. The indicator may be a color-coded indicator bar.

With reference to FIGS. 1-3, the operation of the battery power unit 30 will now be explained. When desired by the user, the mobile phone is charged by the batter power unit 30. The battery power unit is particularly useful for the occasion when AC power is not available. Readily available conventional batteries 50 are inserted into empty battery receptacles 32. Each conventional battery is aligned to position the positive end of the battery with the positive terminal 40 and the negative end with the negative terminal 42. The amount of available power may be indicated by the indicator display 54. Once the conventional batteries are inserted into the receptacles 32, the adapter plug 52 located on the end of the power cord 34 is attached to the power port 24 of the mobile phone 10. The converter provides any change to the electricity (e.g., step up the voltage) as well as draws all the power of the batteries as necessary to power the mobile phone or charge the mobile phone battery. The use of a converter and any associated circuits are well known in the art and it should be understood that any device which converts the available power from the battery into a ready source of electricity for the mobile phone may be utilized.

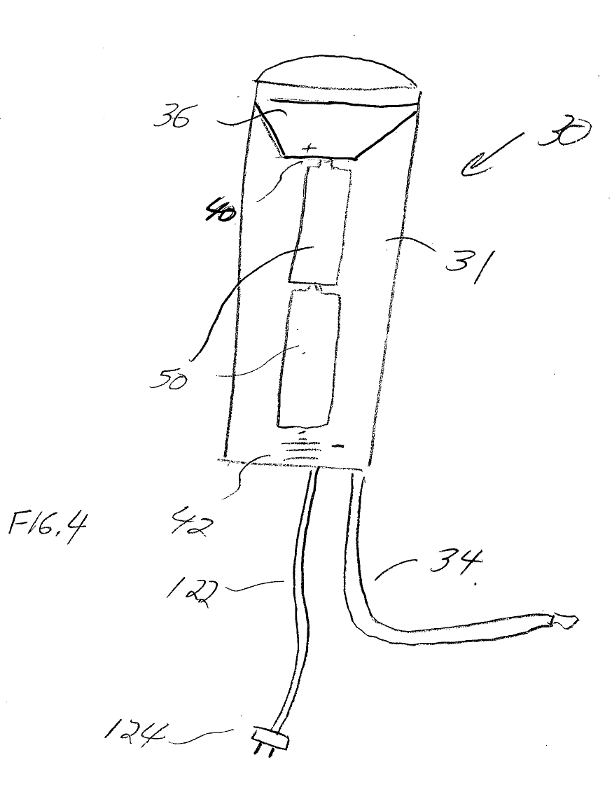

FIG. 4 is a front perspective view of a battery power unit 30 having an optional AC adapter cable 122 and AC plug 124 in an alternate embodiment of the present invention. The battery power unit may include an AC adapter cable which may be used to provide power to the conventional batteries 50 which are rechargeable. Thus, when desired, the batteries 50 being used to power the mobile phone 10 may be charged from an AC power source. In this alternate embodiment, the battery power unit includes the circuitry (not shown) to convert the received AC power into a DC power source for charging the conventional batteries 50.

The present invention provides may advantages over existing devices. Currently, mobile phones require the use of an adapter connected to either an AC outlet or other stationary power source such as a cigarette lighter in an automobile. The present invention provides a portable power source to power a mobile phone or recharge a mobile phone's battery. The present invention is useful when AC power is not available, as is common during the occurrence of a natural disaster.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A battery power unit for powering a mobile phone, the power unit comprising:
a main body having at least one receptacle for housing a conventional DC battery, the receptacle having a positive terminal and a negative terminal;
means for adjusting the electrical output from the conventional battery to an electrical input acceptable for the mobile phone;
a power cable connected to the main body; and
a phone adapter plug connected to the power cable, the phone adapter plug sized and shaped to fit within a power port of the mobile phone;
whereby at least one battery is positioned within the receptacle with the positive end of the battery aligned with the positive terminal and the negative end of the battery is aligned with the negative terminal, the plug adapter being inserted into the power port and the power unit provides power to the mobile phone.

2. The battery power unit of claim 1 wherein the battery power unit provides power to operate the mobile phone.

3. The battery power unit of claim 1 wherein the battery power unit provides power to charge an internally mounted battery pack of the mobile phone.

4. The battery power unit of claim 1 further comprising an indicator to provide an indication of the strength of the conventional battery.

5. The battery power unit of claim 4 wherein the indicator includes a bar display to indicate the strength of the conventional battery.

6. The battery power unit of claim 1 wherein the conventional battery is rechargeable.

7. The battery power unit of claim 6 wherein the battery power unit includes an AC adapter cable and plug, the AC adapter cable providing AC power to the battery power unit to recharge the rechargeable battery.

8. The battery power unit of claim 1 wherein the means for adjusting the electrical output from the conventional battery is an electrical converter.

9. The battery power unit of claim 8 wherein the converter changes the voltage of the conventional battery to a level appropriate for the mobile phone.

10. A method of powering a mobile phone, the method comprising the steps of:
inserting at least one conventional battery into a battery power unit;
converting the electrical power output of the conventional battery into an acceptable voltage for use by the mobile phone;
attaching a cable from the battery power unit to the mobile phone; and
powering the mobile phone from the conventional battery.

11. The method of powering a mobile phone of claim 10 wherein the conventional battery is rechargeable and further comprising the step of charging the rechargeable conventional battery.

12. The method of powering a mobile phone of claim 10, after the step of inserting at least one conventional battery into the battery power unit, the step of providing an indication by the battery power unit of the strength of the conventional battery.

13. A system of powering a mobile phone, the system comprising:
a main body having at least one receptacle for housing a conventional battery, the receptacle having a positive terminal and a negative terminal;
means for adjusting the electrical output from the conventional battery to a voltage level acceptable for the mobile phone;
a power cable connected to the main body;
a phone adapter plug connected to the power cable, the phone adapter plug sized and shaped to fit within a power port of the mobile phone;
at least one battery inserted within the receptacle, the positive end of the battery aligned with the positive terminal and the negative end of the battery is aligned with the negative terminal;
whereby the plug adapter is inserted into the power port of the mobile phone and the power unit provides power to the mobile phone.

14. The battery power unit of claim 13 further comprising an indicator to provide an indication of the strength of the conventional battery.

15. The battery power unit of claim 14 wherein the indicator includes a bar display to indicate the strength of the conventional battery.

16. The battery power unit of claim 13 wherein the conventional battery is rechargeable.

17. The battery power unit of claim 16 wherein the battery power unit includes an AC adapter cable and plug, the AC adapter cable providing AC power to the battery power unit to recharge the rechargeable battery.

18. The battery power unit of claim 13 wherein the means for adjusting the electrical output from the conventional battery is an electrical converter.

19. The battery power unit of claim 18 wherein the converter changes the voltage of the conventional battery to a level appropriate for the mobile phone.
